(19) United States
(12) Patent Application Publication
(10) Pub. No.: US 2019/0246831 A1
(43) Pub. Date: Aug. 15, 2019

(54) TRANSFER CAVITY, MATERIAL SUPPLYING SYSTEM, AND COOKING APPLIANCE

(71) Applicant: FOSHAN SHUNDE MIDEA ELECTRICAL HEATING APPLIANCES MANUFACTURING CO., LIMITED, Foshan, Guangdong Province (CN)

(72) Inventors: Dianguo Pan, Foshan (CN); Weijie Chen, Foshan (CN); Xiaokai Liu, Foshan (CN); Ya Zhou, Foshan (CN); Ruoyu Mei, Foshan (CN)

(21) Appl. No.: 16/343,759

(22) PCT Filed: Sep. 6, 2017
(86) PCT No.: PCT/CN2017/100805

§ 371 Date: Apr. 20, 2019

(30) Foreign Application Priority Data
Oct. 20, 2016 (CN) 201610915359.0
Oct. 20, 2016 (CN) 201621144280.4

(51) Int. Cl. A47J 27/08; A47J 36/14

(52) U.S. Cl. CPC A47J 27/0802; A47J 27/0817; A47J 36/14

(57) ABSTRACT

The present disclosure provides a transfer cavity, a material supplying system and a cooking appliance. The transfer cavity has an inner cavity, and is provided with a material inlet, a material outlet and a fluid inlet, and the inner cavity communicates with the material inlet, the material outlet and the fluid inlet, wherein the fluid inlet is arranged on a bottom wall of the transfer cavity or a position on a side wall of the transfer cavity that is relatively close to the bottom wall of the transfer cavity. According to the transfer cavity provided by the solution, the air may approximately enter the transfer cavity from the bottom of the transfer cavity, thereby being conducive to lifting and dispersing a material by wind power, and avoiding the problem that it is difficult to drive and discharge the material due to the accumulation of the material in the transfer cavity. Therefore, complete discharge and no residue in the transfer cavity may be ensured, and the hygienic security of the product may be improved.

### PRIORITY CLAIM AND RELATED APPLICATION

The present disclosure is a national phase application of International Application No. PCT/CN2017/100805, filed on Sep. 6, 2017, which claims the priority of Chinese Application No. 201621144280.4, filed in the Chinese Patent Office on Oct. 20, 2016, and entitled “TRANSFER CAVITY, MATERIAL SUPPLYING SYSTEM, AND COOKING APPLIANCE”, and claims the priority of Chinese Application No. 201610915359.0, filed in the Chinese Patent Office on Oct. 20, 2016, and entitled “MATERIAL CONVEYING DEVICE, KITCHEN STORAGE, AND COOKING APPLIANCE”, the entirety of which is herein incorporated by reference.

### TECHNICAL FIELD

The present disclosure relates to the field of kitchen appliances, and in particular to a transfer cavity, a material supplying system and a cooking appliance.

### BACKGROUND

In existing cooking appliances such as automatic rice cookers, it is necessary to drive the rice to flow between components such as rice boxes, rice washers, cooker bodies and the like, in order to realize automatic rice feeding, rice washing and rice moving actions. To this end, some of the existing rice cookers are provided with transfer structures for mixing air or water and other media with the rice to transfer the rice through the fluid. However, the transfer structures usually involve a large number of circulation ports and have complex structures, the problem of incomplete discharge caused by material stagnation and residue because of improper designs is generated, and mildew and deterioration of materials may be caused by long-term stagnation of the materials, resulting in health and safety hazards of the product.

### SUMMARY

An embodiment of the first aspect of the present disclosure provides a transfer cavity, the transfer cavity has an inner cavity, the transfer cavity is provided with a material inlet for the inflow of a material, a material outlet for the outflow of the material and a fluid inlet for the entry of fluid medium, and the inner cavity communicates with the material inlet, the material outlet and the fluid inlet, wherein the fluid inlet is arranged on a bottom wall of the transfer cavity or a position on a side wall of the transfer cavity that is relatively close to the bottom wall of the transfer cavity.

It may be understood that, the fluid medium may be water or air. Considering the problems that the water easily causes an adhesion problem of the material to the wall, and that the driving force loss of the air is less than that of the water, the air is used as the fluid medium to drive the material in the present solution. In view of this, the present solution is illustrated below by mainly using the air as the fluid medium.

According to the transfer cavity provided by the present disclosure, the fluid inlet is arranged on the bottom wall of the transfer cavity or the position on the side wall of the transfer cavity that is relatively close to the bottom wall of the transfer cavity, so that the air may approximately enter the transfer cavity from the bottom of the transfer cavity, thereby being conducive to lifting and dispersing the material by wind power, and avoiding the problem that it is difficult to drive and discharge the material due to the accumulation of the material in the transfer cavity. Therefore, complete discharge and no residue in the transfer cavity may be ensured, and the hygienic security of the product may be improved.

In addition, the transfer cavity in the above embodiment provided by the present disclosure may further have the following additional technical features.

In one embodiment, a minimum distance between an intersecting line of the fluid inlet on the transfer cavity and the bottom wall of the transfer cavity satisfies: T≤10 mm.

In the present solution, the minimum distance T between the intersecting line of the fluid inlet on the transfer cavity and the bottom wall of the transfer cavity is not greater than 10 mm, wherein the minimum distance T between the intersecting line of the fluid inlet on the transfer cavity and the bottom wall of the transfer cavity should be designed as small as possible if the design allows, thereby being conducive to lifting and dispersing the material by wind power, and avoiding the problem that it is difficult to drive and discharge the material due to the accumulation of the material in the transfer cavity. Therefore, complete discharge and no residue in the transfer cavity may be ensured.

In one embodiment, in the case that the fluid inlet is located at the position on the side wall of the transfer cavity that is relatively close to the bottom wall of the transfer cavity, the minimum distance between the intersecting line of the fluid inlet on an inner surface of the transfer cavity and the bottom wall of the transfer cavity is 0 mm to 5 mm.

In the present solution, the fluid inlet is located at the position on the side wall of the transfer cavity that is relatively close to the bottom wall of the transfer cavity, the minimum distance between the intersecting line of the fluid inlet on the transfer cavity and the bottom wall of the transfer cavity is 0 mm to 5 mm, and the minimum distance between the intersecting line of the fluid inlet on the transfer cavity and the bottom wall of the transfer cavity should be designed as small as possible if the design allows, thereby being conducive to lifting and dispersing the material by wind power, and avoiding the problem that the material is difficult to discharge due to accumulation in the transfer cavity. Therefore, complete discharge and no residue in the transfer cavity may be ensured.

In one embodiment, an included angle between an axis of the fluid inlet and the bottom wall of the transfer cavity is 0° to 90°, so that the fluid medium entering from the fluid inlet is injected from the bottom wall of the transfer cavity or is injected onto the bottom wall of the transfer cavity and reflected by the bottom wall of the transfer cavity.

In the present solution, the included angle between the axis of the fluid inlet and the bottom wall of the transfer cavity is 0° to 90°, specifically, the fluid inlet may be arranged on the bottom wall of the transfer cavity, and the included angle between the axis of the fluid inlet and the bottom wall of the transfer cavity is 0° to 90°, the material outlet is located on one side of the downstream of the airflow, the included angle between the axis of the fluid inlet and the bottom wall of the transfer cavity is greater than 0°, it may be further preferably set that the included angle between the axis of the fluid inlet and the bottom wall of the transfer cavity is 20° to 70°, and it is further preferably set that the included angle between the axis of the fluid inlet and the bottom wall of the transfer cavity is 30° to 60°. In this way, the airflow entering along the fluid inlet is injected from the bottom wall of the transfer cavity, thereby being conducive to lifting and dispersing the material by wind power, and thus the problems that the wind power driving loss is large due to the concentrated accumulation of the material, and that the material discharge is incomplete due to difficult material driving may be avoided. In addition, the flow inlet may be arranged at the position on the side wall of the transfer cavity that is relatively close to the bottom wall of the transfer cavity, the included angle between the axis of the fluid inlet and the bottom wall of the transfer cavity is 0° to 90°, and the material outlet is located on the airflow ejection side, in this way, the airflow entering along the fluid inlet may be injected onto the bottom wall of the transfer cavity and is reflected by the bottom wall of the transfer cavity, thereby being conducive to lifting and dispersing the material by wind power, and thus the problems that the wind power driving loss is large due to the accumulation of the material and that the material discharge is incomplete due to difficult material driving may be avoided.

In one embodiment, the fluid inlet is arranged to be opposite to the material outlet, and the axis of the material inlet passes through an area between the fluid inlet and the material outlet.

Since the fluid inlet is arranged to be opposite to the material outlet, the material outlet is directly located at the downstream of the airflow direction, in addition, it is configured that the axis of the material inlet passes through the area between the fluid inlet and the material outlet, so that the material entering from the material inlet may directly drop into and accumulate in the area between the fluid inlet and the material outlet. In this way, the airflow entering from the fluid inlet may directly drive the material to be discharged from the material outlet along a downwind direction, thereby avoiding the problem of material residue, effectively improving the conveying efficiency of the product, reducing the kinetic energy loss of the airflow in the transfer cavity and effectively ensuring the energy efficiency of the product.

In one embodiment, the material inlet faces to the center of the transfer cavity, the fluid inlet is located at one end of the transfer cavity, and the material outlet is located on the other end of the transfer cavity relative to the fluid inlet.

In the present solution, the material inlet is arranged toward the center of the transfer cavity, the fluid inlet is located at one end of the transfer cavity, and the material outlet is located on the other end of the transfer cavity relative to the fluid inlet, when the axis of the material inlet passes through the area between the fluid inlet and the material outlet, the fluid inlet may be oriented substantially toward the center of the transfer cavity, in this way, most of the airflow entering along the fluid inlet may directly drive the material at the central position of the transfer cavity to move toward the material outlet along a straight line passing though the center of the transfer cavity, and a small part of the airflow may be split from the two sides to clear the material surrounding the center of the transfer cavity, thereby avoiding the problem of material residue.

In one embodiment, the orientation of the fluid inlet deviates from the center of the transfer cavity, such that the fluid medium entering from the fluid inlet flows around the center of the transfer cavity along a wall surface of the transfer cavity, wherein the material inlet is located on the wall surface of the transfer cavity through which the fluid medium flows.

In the present solution, it is configured that the orientation of the fluid inlet deviates from the center of the transfer cavity, such that the airflow entering the transfer cavity along the fluid inlet has a tangential speed, therefore, the airflow may flow around the center of the transfer cavity along the wall surface of the transfer cavity. In addition, the material inlet is located on the wall surface of the transfer cavity through which the fluid medium flows (for example, the side wall of the transfer cavity through which the fluid medium flows), so that the material entering along the material inlet may fall directly onto a flow track of the airflow in the transfer cavity, thereby being beneficial for the airflow to drive the material discharge so as to avoid the problem of material residue.

In one embodiment, a minimum horizontal distance B between a lowest point of the intersecting line of the material inlet on the transfer cavity and the intersecting line of the fluid inlet on the transfer cavity satisfies: B≤10 mm.

In the present solution, it is configured that the minimum horizontal distance B between the lowest point of the intersecting line of the material inlet on the transfer cavity and the intersecting line of the fluid inlet on the transfer cavity is not greater than 10 mm, therefore, the problem that the distance between the fluid inlet and the feeding position of the material is too large may be avoided. In this way, the concentrated airflow entering along the fluid inlet may concentrate on driving the material located on the flow track of the airflow to avoid the problem of material residue.

In one embodiment, the material outlet is located at a joint of the bottom wall of the transfer cavity and the side wall of the transfer cavity, and the height of the position where the lowest point of the material outlet is located is not greater than the height of the position where the inner surface of the bottom wall of the transfer cavity is located; or the material outlet is located on the bottom wall of the transfer cavity.

In the present solution, it is configured that the height of the position where the lowest point of the material outlet is located is not greater than the height of the position where the inner surface of the bottom wall of the transfer cavity is located, therefore, the wind power may completely discharge the material from the material outlet by pushing, and the problem of material residue resulting from that the position of the material outlet is too high and that it is difficult to lift the material by wind power is avoided.

In the present solution, the material outlet is located on the bottom wall of the transfer cavity, or the material outlet is located at the position on the side wall of the transfer cavity that is relatively close to the bottom wall of the transfer cavity, therefore, the wind power may completely discharge the material from the material outlet by pushing, and the problem of material residue resulting from that the position of the material outlet is too high and that it is difficult to lift the material by wind power is avoided.

In one embodiment, the transfer cavity takes the shape of a three-way pipe. Since the transfer cavity takes the shape of the three-way pipe, the structure is simple and easy to manufacture, and the cost of the product may be relatively reduced; or a top wall of the transfer cavity takes the shape of an upward protruding arc, the side wall of the transfer cavity takes the shape of an arc and is connected between the top wall of the transfer cavity and the bottom wall of the transfer cavity for transition. In this way, the number of corner structures in the transfer cavity may be reduced, and the problem that the material is difficult to be discharged when being blocked and left in the corner structures is avoided, thereby avoiding the safety and health hazards of the product; or the transfer cavity includes a cavity bottom wall and a cavity top wall, the cavity top wall takes the shape of an upward protruding arc at the middle, and the edge of the cavity top wall is connected to the edge of the cavity bottom wall.

In one embodiment, the material inlet is located on the side wall of the transfer cavity or on the top wall of the transfer cavity.

The embodiment of the second aspect of the present disclosure provides a material supplying system, including: the transfer cavity according to any one of the above technical solutions; and a power device connected to the fluid inlet of the transfer cavity for driving the fluid medium to enter the transfer cavity.

The material supplying system provided by the present disclosure has all the above beneficial effects due to the provision of the transfer cavity In one embodiment, and thus is not described herein again.

In one embodiment, the material supplying system further includes a material storage device connected to the material inlet of the transfer cavity, the material storage device is used for storing the material, and the material stored in the material storage device is supplied to the transfer cavity.

In the present solution, the material storage device is configured to store the material in advance, in this way, the material storage device may automatically supply the material to the transfer cavity when feeding is needed, a user does not need to manually supplement the material every time, and the use convenience of the product is improved.

In one embodiment, the material supplying system further includes a feed valve, the material inlet of the transfer cavity is connected to the material storage device through the feed valve, and the feed valve is used for controlling the connection and disconnection between the material inlet and the material storage device.

In the present solution, the feed valve is configured to control the connection and disconnection of the material inlet, in this way, in the case of discontinuous feeding at the material outlet, when the power device is started, the connection and disconnection of the material inlet may be controlled by the feed valve to prevent the material in the transfer cavity from generating backflow along the material inlet, and meanwhile, adverse effects such as wind energy loss at the material outlet may be avoided to ensure the energy efficiency of the product.

Of course, the present solution is not limited thereto, and the feed valve may not be provided. Specifically, in the case of the discontinuous feeding at the material outlet, the material inlet may be blocked by the continuous flowing of the material at the material outlet to achieve the purposes of reducing the wind energy loss and avoiding the backflow of the material.

In one embodiment, the position of the material storage device of the material supplying system is lower than or higher than the position of the cooking appliance; and/or, the material storage device of the material supplying system is located above or below the cooking appliance.

In one embodiment, the power device is a blower device for blowing air into the transfer cavity.

The blower device is used for blowing air into the transfer cavity, in this way, the material in the transfer cavity may be driven to be discharged from the material outlet via wind power, and the material is further transported into a receiving device such as a cooking ware of the cooking appliance to realize a transfer process of the material. Compared with the transport solution adopting a hydraulic impact manner, the wind power driving manner may realize dry material transport, thereby avoiding the problem of material residue caused by the attachment of the material on the inner wall of the pipeline by the transport water, thereby effectively ensuring the sanitary safety of the product. In addition, compared with the transport solution of using a gravity dropping manner in the prior at, the material is driven by wind power in the present solution to overcome the gravity of the material so as to transport and lift the material, so that the product may be applied to transportation occasions with different needs, which is conducive to product promotion in the field.

The blower device is a fan or an air pump.

In one embodiment, the material supplying system further includes an air inlet pipe, and the blower device is connected to the fluid inlet through the air inlet pipe.

In the present scheme, the spatial layout of the position of the blower device may be facilitated by the air inlet pipe, and at the same time, the flexible connection between the blower device and the fluid inlet may be realized, thereby achieving a vibration damping effect of the whole machine and reducing the running noise.

In one embodiment, the pipe diameter of the air inlet pipe is uniform from one end of the air inlet pipe to the other end of the air inlet pipe; or the pipe diameters of both ends of the air inlet pipe are greater than the pipe diameter at the middle.

In the present solution, it is configured that the pipe diameter of the air inlet pipe is uniform from one end of the air inlet pipe to the other end of the air inlet pipe, especially in the case where the blower device is a fan, such configuration may relatively reduce the flow resistance at the air inlet pipe and improve the driving efficiency of the fluid; and it is configured that the pipe diameters of both ends of the air inlet pipe are greater than the pipe diameter at the middle, especially in the case where the blower device is an air pump, the driving effect of the airflow by the air pump may be enhanced by the injection function of the air inlet pipe structure.

In one embodiment, the material supplying system further includes a material transport pipe, one end of the material transport pipe is connected to the material outlet of the transfer cavity, and the other end of the material transport pipe communicates with a cooking ware of a cooking appliance.

It is configured that one end of the material transport pipe is connected to the material outlet of the transfer cavity, and the other end of the material transport pipe communicates with the cooking ware of the cooking appliance, that is, the material outlet is not directly connected to the cooking ware of the cooking appliance, thereby being conducive to the spatial layout of the product and the cooking ware of the cooking appliance, widening the application occasions of the product and facilitating the promotion of the product in the field.

An embodiment of the third aspect of the present disclosure provides a cooking appliance, including: a cooking main body including a cooking ware; and the material supplying system In one embodiment, wherein the material outlet of the transfer cavity of the material supplying system communicates with the cooking ware.

The cooking appliance provided by the present disclosure is provided with the material supplying system In one embodiment, thereby having all the above beneficial effects, and is not described herein again.

In one embodiment, the cooking appliance is a rice cooker, an electric pressure cooker, an electric cooker, an electric steamer or a soybean milk machine.

Additional aspects and advantages of the present disclosure will become apparent in the following description, or are understood by the practice of the present disclosure.

### BRIEF DESCRIPTION OF DRAWINGS

The above and/or additional aspects and advantages of the present disclosure will become apparent and readily understood from the following descriptions of embodiments in combination with the drawings:

FIG. 1 is a structural diagram of a cooking appliance in an embodiment of the present disclosure;

FIG. 2 is a top view diagram of a transfer cavity in an embodiment of the present disclosure;

FIG. 3 is a sectional view of the transfer cavity as shown in FIG. 2;

FIG. 4 is a top view diagram of a transfer cavity in an embodiment of the present disclosure;

FIG. 5 is a sectional view of the transfer cavity as shown in FIG. 4;

FIG. 6 is a structural diagram of a cooking appliance in an embodiment of the present disclosure;

FIG. 7 is a structural diagram of a cooking appliance in an embodiment of the present disclosure;

FIG. 8 is a structural diagram of a cooking appliance in an embodiment of the present disclosure.

Arrows as shown in FIG. 1 to FIG. 8 indicate airflow directions.

The corresponding relationship between reference signs and corresponding component names in FIG. 1 to FIG. 3 is as follows:

10 transfer cavity, 11 material inlet, 12 material outlet, 13 fluid inlet, 14 intersecting line of the material inlet on the transfer cavity, 15 intersecting line of the fluid inlet on the transfer cavity, 16 cavity bottom wall, 17 cavity top wall, 20 fan, 30 material storage device, 40 feed valve, 50 cooking ware, 60 air inlet pipe, 70 material transport pipe.

### DETAILED DESCRIPTION OF EMBODIMENTS

Embodiments of the present disclosure will be further described in detail below in combination with drawings. It should be noted that the embodiments of the present application and the features in the embodiments may be combined with each other without conflicts.

In the following description, numerous specific details are set forth in order to provide a full understanding of the present disclosure, but the present disclosure may be practiced otherwise than as described herein. Therefore, the protection scope of the present disclosure is not limited by specific embodiments disclosed below.

The cooking appliance, the material supplying system and the transfer cavity according to some embodiments of the present disclosure are described below with reference to FIG. 1 to FIG. 8.

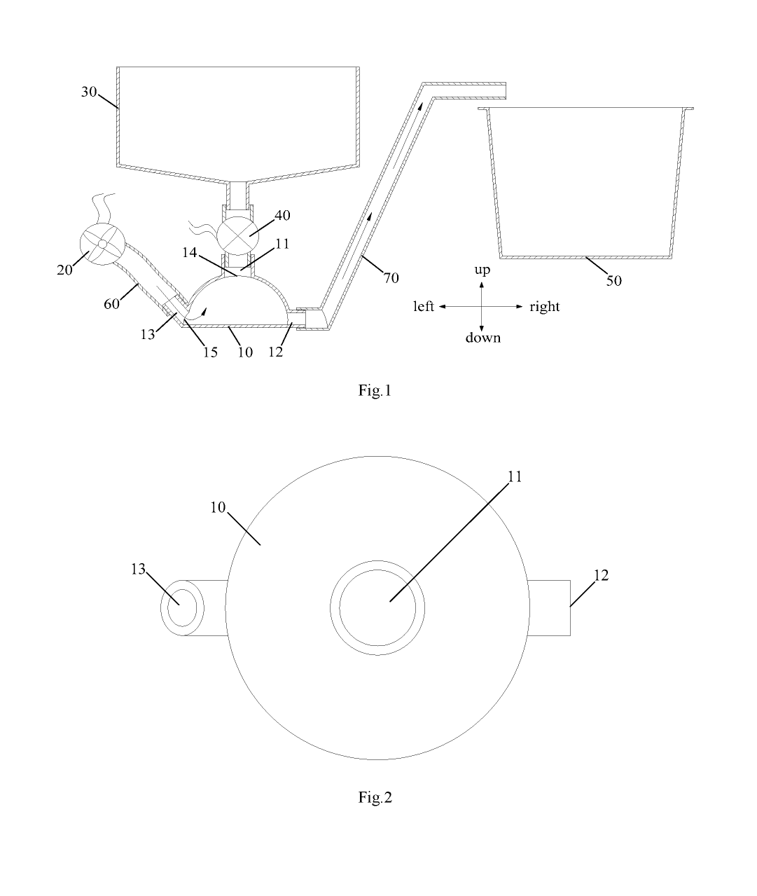

As shown in FIG. 2 to FIG. 5, the embodiment provides a transfer cavity 10, the transfer cavity 10 has an inner cavity, that is, the transfer cavity 10 is a hollow cavity, the inner cavity is used for mixing fluid medium with materials suitable for cooking and eating such as rice, soy beans, mung beans and the like, the transfer cavity 10 is provided with a material inlet 11 for the inflow of a material, a material outlet 12 for the outflow of the material and a fluid inlet 13 for the entry of fluid medium, and the inner cavity communicates with the material inlet 11, the material outlet 12 and the fluid inlet 13; wherein the fluid inlet 13 is arranged on a bottom wall of the transfer cavity 10 or a position on a side wall of the transfer cavity 10 that is relatively close to the bottom wall of the transfer cavity 10.

It may be understood that, the fluid medium may be water or air. Considering the problem that the water easily causes a wall attachment and adhesion problem of the material and that the driving force loss of the air is less than that of the water, the air is preferably used as the fluid medium to drive the material in the present solution. In view of this, the present solution is illustrated below by mainly using the air as the fluid medium.

According to the transfer cavity 10 provided by the present disclosure, the material inlet 11 is located on the bottom wall of the transfer cavity 10 or on a top wall of the transfer cavity 10. Compared with the solution that the fluid inlet 11 is arranged on the bottom wall of the transfer cavity 10, the power consumed for driving the material to ascend may be reduced, the fluid inlet 13 is arranged on the bottom wall of the transfer cavity 10 or the position on the side wall of the transfer cavity 10 that is relatively close to the bottom wall of the transfer cavity 10, so that the air may approximately enter the transfer cavity 10 from the bottom of the transfer cavity 10, thereby being conducive to lifting and dispersing the material by wind power, and avoiding the problem that it is difficult to drive and discharge the material due to the accumulation of the material in the transfer cavity 10. Therefore, complete discharge and no residue in the transfer cavity 10 may be ensured, and the hygienic security of the product may be improved.

In one embodiment, the material inlet 11 is located on the side wall of the transfer cavity 10 or located on the top wall of the transfer cavity 10, which can reduce the power consumption for driving the material to ascend compared with the solution that the fluid inlet 11 is arranged on the bottom wall of the transfer cavity 10.

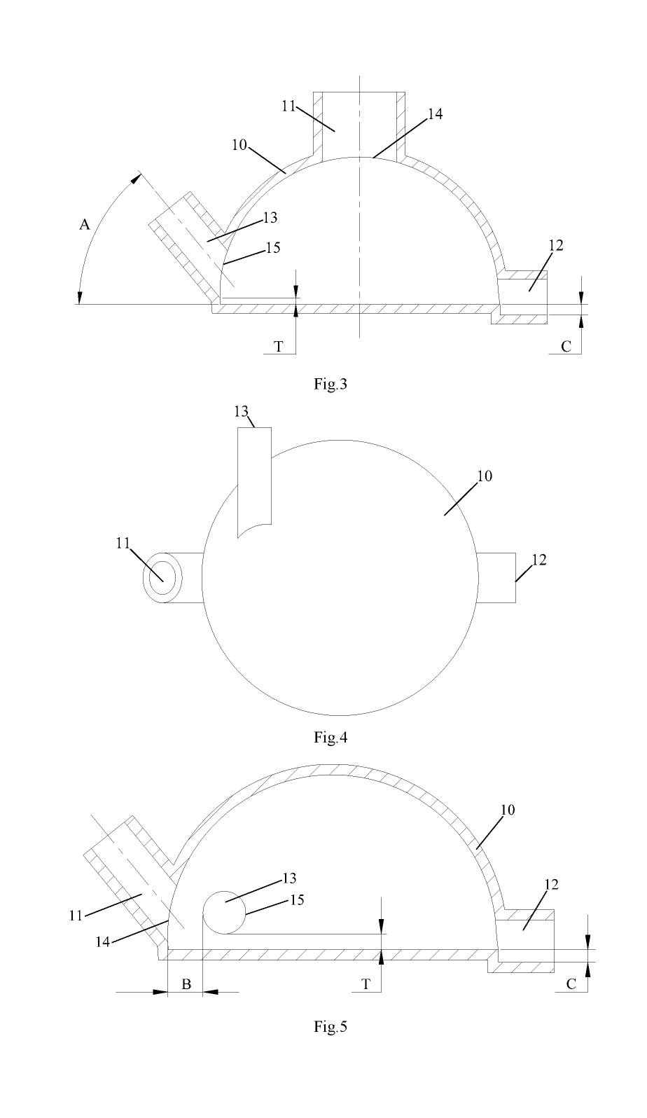

In some embodiments of the present disclosure, as shown in FIG. 3 and FIG. 5, a minimum distance T between an intersecting line 15 of the fluid inlet 13 on the transfer cavity 10 and the bottom wall of the transfer cavity 10 satisfies: T≤10 mm.

In the present solution, the minimum distance T between the intersecting line 15 of the fluid inlet 13 on the transfer cavity 10 and the bottom wall of the transfer cavity 10 is not greater than 10 mm, wherein the minimum distance T between the intersecting line 15 of the fluid inlet 13 on the transfer cavity 10 and the bottom wall of the transfer cavity 10 should be designed as small as possible if the design allows, thereby being conducive to lifting and dispersing the material by wind power, and avoiding the problem that it is difficult to drive and discharge the material due to the accumulation of the material in the transfer cavity 10. Therefore, complete discharge and no residue in the transfer cavity 10 may be ensured.

In one embodiment of the present disclosure, as shown in FIG. 1 to FIG. 4, the fluid inlet 13 is located at the position on the side wall of the transfer cavity 10 that is relatively close to the bottom wall of the transfer cavity 10, further, the minimum distance between the intersecting line 15 of the fluid inlet 13 on an inner surface of the transfer cavity 10 and the bottom wall of the transfer cavity 10 is 0 mm to 5 mm, and the minimum distance between the intersecting line of the fluid inlet 13 on the transfer cavity 10 and the bottom wall of the transfer cavity 10 should be designed as small as possible if the design allows, so that the airflow may appropriately enter the transfer cavity 10 from the bottom of the transfer cavity 10, thereby being conducive to lifting and dispersing the material by wind power, and avoiding the problem that the material is difficult to discharge due to accumulation in the transfer cavity 10. Therefore, complete discharge and no residue in the transfer cavity 10 may be ensured.

Of course, the present solution is not limited by the above embodiment, and the fluid inlet 13 may also be arranged on the bottom wall of the transfer cavity 10 as needed.

In one embodiment of the present disclosure, as shown in FIG. 3, a dotted line slanted with respect to a vertical line in the figure illustrates the axis of the fluid inlet 13, the axis is an assumed auxiliary line, which may indicate that the flow direction of the fluid at the fluid inlet 13 is mainly inward along the axis, in the case that the fluid inlet 13 is a circular opening, an elliptical opening, a square opening or a rectangular opening, the axis may be collinear with the center line of the circular, elliptical, square or rectangular fluid inlet 13. In the present solution, an included angle A between the axis of the fluid inlet 13 and the bottom wall of the transfer cavity 10 is set as 0° to 90°, so that the fluid medium entering from the fluid inlet 13 is injected from the bottom wall of the transfer cavity 10 or is injected onto the bottom wall of the transfer cavity 10 and is reflected by the bottom wall of the transfer cavity 10.

In the present solution, the included angle between the axis of the fluid inlet 13 and the bottom wall of the transfer cavity 10 is set as 0° to 90°, specifically, the fluid inlet 13 may be arranged on the bottom wall of the transfer cavity 10, and the included angle between the axis of the fluid inlet 13 and the bottom wall of the transfer cavity 10 is 0° to 90°, the material outlet 12 is located on one side of the downstream of the airflow, in this way, the airflow entering along the fluid inlet 13 is injected from the bottom wall of the transfer cavity 10, thereby being conducive to lifting and dispersing the material by wind power, and thus the problems that the wind power driving loss is large due to the accumulation of the material, and that the material discharge is incomplete due to difficult material driving may be avoided. In addition, as shown in FIG. 3, the flow inlet 13 may be arranged at the position on the side wall of the transfer cavity 10 that is relatively close to the bottom wall of the transfer cavity 10, the included angle between the axis of the fluid inlet 13 and the bottom wall of the transfer cavity 10 is 0° to 90°, and the material outlet 12 is located on the airflow ejection side, in this way, the airflow entering along the fluid inlet 13 may be injected onto the bottom wall of the transfer cavity 10 and reflected by the bottom wall of the transfer cavity 10, thereby being conducive to lifting and dispersing the material by wind power, and thus the problems that the wind power driving loss is large due to the accumulation of the material and that the material discharge is incomplete due to difficult material driving may be avoided.

In one embodiment of the present disclosure, as shown in FIG. 1 to FIG. 3, the fluid inlet 13 is arranged to be opposite to the material outlet 12, and the axis of the material inlet 11 passes through an area between the fluid inlet 13 and the material outlet 12; and it is worth noting that, as shown in FIG. 3, a vertically arranged dotted line in the figure illustrates the axis of the material inlet 11, the axis is an assumed auxiliary line, which may indicate that the flow direction of the fluid at the material inlet 11 is mainly inward along the axis. In the case that the material inlet 11 is a circular opening, an elliptical opening, a square opening or a rectangular opening, the axis may be collinear with the center line of the circular, elliptical, square or rectangular material inlet 11.

In the present solution, since the fluid inlet 13 is arranged to be opposite to the material outlet 12, and the axis of the material inlet 11 passes through the area between the fluid inlet 13 and the material outlet 12, in this way, the material entering along the material inlet 11 may directly drop into the area between the fluid inlet 13 and the material outlet 12, so that the airflow entering from the fluid inlet 13 may directly push out the material from the material outlet 12 along a downwind direction, thereby avoiding the problem of material residue.

In one embodiment of the present disclosure, as shown in FIG. 1 to FIG. 3, the material inlet 11 faces to the center of the transfer cavity 10, the fluid inlet 13 is located at one end of the transfer cavity 10, and the material outlet 12 is located on the other end of the transfer cavity 10 relative to the fluid inlet 13.

In the present solution, the material inlet 11 is arranged toward the center of the transfer cavity 10, the fluid inlet 13 is located at one end of the transfer cavity 10, and the material outlet 12 is located on the other end of the transfer cavity 10 relative to the fluid inlet 13. when the axis of the material inlet 11 passes through the area between the fluid inlet 13 and the material outlet 12, the fluid inlet 13 may be oriented substantially toward the center of the transfer cavity 10, in this way, most of the airflow entering along the fluid inlet 13 may directly drive the material at the central position of the transfer cavity 10 to move toward the material outlet 12 along a straight line passing though the center of the transfer cavity 10, and a small part of the airflow may be split from the two sides to clear the material surrounding the center of the transfer cavity 10, thereby avoiding the problem of material residue.

In one embodiment of the present disclosure, as shown in FIG. 4 and FIG. 5, the orientation of the fluid inlet 13 deviates from the center of the transfer cavity 10, such that the fluid medium entering from the fluid inlet 13 flows around the center of the transfer cavity 10 along a wall surface of the transfer cavity 10, wherein the material inlet 11 is located on the wall surface of the transfer cavity 10 through which the fluid medium flows (for example, the side wall of the transfer cavity 10 through which the airflow flows).

In the present solution, it is configured that the orientation of the fluid inlet 13 deviates from the center of the transfer cavity 10, such that the airflow entering the transfer cavity 10 along the fluid inlet 13 has a tangential speed, therefore, the airflow may flow around the center of the transfer cavity 10 along the wall surface of the transfer cavity 10. In addition, the material inlet 11 is located on the wall surface of the transfer cavity 10 through which the airflow flows, so that the material entering along the material inlet 11 may fall directly onto a flow track of the airflow in the transfer cavity 10, thereby being beneficial for the airflow to drive the material discharge so as to avoid the problem of material residue.

In one embodiment of the present disclosure, as shown in FIG. 5, a minimum horizontal distance B between a lowest point of the intersecting line 14 of the material inlet 11 on the transfer cavity 10 and the intersecting line 15 of the fluid inlet 13 on the transfer cavity 10 satisfies: B≤10 mm.

In the present solution, it is configured that the minimum horizontal distance B between the lowest point of the intersecting line 14 of the material inlet 11 on the transfer cavity 10 and the intersecting line 15 of the fluid inlet 13 on the transfer cavity 10 is not greater than 10 mm, therefore, the problem that the distance between the fluid inlet 13 and the feeding position of the material is too large may be avoided, in this way, the concentrated airflow entering along the fluid inlet 13 may concentrate on driving the material located on the flow track of the airflow to avoid the problem of material residue.

In one embodiment of the present disclosure, as shown in FIG. 3 and FIG. 5, the material outlet 12 is located at a joint of the bottom wall of the transfer cavity 10 and the side wall of the transfer cavity 10, and the height of the position where the lowest point of the material outlet 12 is located is not greater than the height of the position where the inner surface of the bottom wall of the transfer cavity 10 is located, that is, as shown in FIG. 3 and FIG. 5, the distance C between the lowest point of the material outlet 12 and the inner wall surface of the bottom wall of the transfer cavity 10 is greater than equal to 0 mm.

In the present solution, it is configured that the height of the position where the lowest point of the material outlet 12 is located is not greater than the height of the position where the inner surface of the bottom wall of the transfer cavity 10 is located, therefore, the wind power may completely discharge the material from the material outlet by pushing, and the problem of material residue resulting from that the position of the material outlet 12 is too high and that it is difficult to lift the material by wind power is avoided.

In another specific embodiment of the present disclosure, the material outlet 12 is located on the bottom wall of the transfer cavity 10, or the material outlet 12 is located at the position on the side wall of the transfer cavity 10 that is relatively close to the bottom wall of the transfer cavity 10.

In the present solution, it is configured that the material outlet 12 is located on the bottom wall of the transfer cavity 10, or the material outlet 12 is located at the position on the side wall of the transfer cavity 10 that is relatively close to the bottom wall of the transfer cavity 10, therefore, the wind power may completely discharge the material from the material outlet by pushing, and the problem of material residue resulting from that the position of the material outlet 12 is too high and that it is difficult to lift the material by wind power is avoided.

In one specific embodiment of the present disclosure, for the transfer cavity 10 as shown in FIG. 3, the minimum distance T between the intersecting line 15 of the fluid inlet 13 on the transfer cavity 10 and the bottom wall of the transfer cavity 10 is not greater than 10 mm; the fluid inlet 13 is arranged at the position on the side wall of the transfer cavity 10 that is relatively close to the bottom wall of the transfer cavity 10, and the included angle A between the axis of the fluid inlet 13 and the bottom wall of the transfer cavity 10 is set as 0° to 90°; and the material outlet 12 is located on the airflow injection side, the lowest point of the material outlet 12 is not higher than the inner surface of the bottom wall of the transfer cavity 10, and the distance C between the two components is greater than or equal to 0 mm.

In one specific embodiment of the present disclosure, for the transfer cavity 10 as shown in FIG. 5, the minimum distance T between the intersecting line 15 of the fluid inlet 13 on the transfer cavity 10 and the bottom wall of the transfer cavity 10 is not greater than 10 mm; the fluid inlet 13 and the material outlet 12 are respectively located at both ends of the transfer cavity 10, the material inlet 11 is located on the top wall of the transfer cavity 10 and is located between the fluid inlet 13 and the material outlet 12; the minimum horizontal distance B between the lowest point of the intersecting line 14 of the material inlet 11 on the transfer cavity 10 and the intersecting line 15 of the fluid inlet 13 on the transfer cavity 10 is not greater than 10 mm; and the lowest point of the material outlet 12 is not higher than the inner surface of the bottom wall of the transfer cavity 10, and the distance C between the two components is greater than or equal to 0 mm.

In one embodiment of the present disclosure, the transfer cavity takes the shape of a three-way pipe. Since the transfer cavity takes the shape of the three-way pipe, the structure is simple and easy to manufacture, and the cost of the product may be relatively reduced.

In one embodiment of the present disclosure, as shown in FIG. 3 and FIG. 5, the top wall of the transfer cavity 10 takes the shape of an upward protruding arc, the side wall of the transfer cavity 10 takes the shape of an arc and is connected between the top wall of the transfer cavity 10 and the bottom wall of the transfer cavity 10 for transition.

In the present solution, the number of corner structures in the transfer cavity 10 may be reduced, and the problem that the material is difficult to be discharged when being blocked and left in the corner structures is avoided, thereby avoiding the safety and health hazards of the product.

The transfer cavity 10 includes a cavity bottom wall 16 and a cavity top wall 17, the cavity top wall 17 takes the shape of an upward protruding arc at the middle, and the edge of the cavity top wall 17 is connected to the edge of the cavity bottom wall 16. It may be understood that, the bottom wall of the transfer cavity 10 described in any one of the foregoing embodiments may be understood as the cavity bottom wall 16 in the present embodiment, and the side wall of the transfer cavity 10 described in any one of the foregoing embodiments may be understood as a part close to the edge on the cavity top wall 17 in the present embodiment.

In the present solution, it is configured that the transfer cavity 10 includes the cavity bottom wall 16 and the cavity top wall 17, the cavity top wall 17 takes the shape of the upward protruding arc at the middle, and the edge of the cavity top wall 17 is connected to the edge of the cavity bottom wall 16, in this way, the number of corner structures in the transfer cavity 10 may be reduced, and the problem that the material is difficult to be discharged when being blocked and left in the corner structures is avoided, thereby avoiding the safety and health hazards of the product.

In one embodiment, the material inlet is located on the side wall of the transfer cavity or on the top wall of the transfer cavity.

The material supplying system provided by the present embodiment includes the transfer cavity 10 according to the above embodiments and a power device, as shown in FIG. 1, the power device is connected to the fluid inlet 13 of the transfer cavity 10 for driving the fluid medium to enter the transfer cavity 10. The material supplying system is suitable for conveying materials suitable for cooking and eating such as rice, soybeans and mung beans into the cooking ware of the cooking appliance.

The material supplying system provided by the present disclosure has all the above beneficial effects due to the presence of the transfer cavity 10 In one embodiment, and thus is not described herein again.

In one embodiment of the present disclosure, as shown in FIG. 1, the material supplying system further includes a material storage device 30, the material storage device 30 is connected to the material inlet 11 of the transfer cavity 10, the material storage device 30 is used for storing the material, and the material stored in the material storage device 30 is supplied to the transfer cavity 10.

In the present solution, the material storage device 30 is configured to store the material in advance, in this way, the material storage device 30 may automatically supply the material to the transfer cavity 10 when feeding is needed, a user does not need to manually supplement the material every time, and the use convenience of the product is improved.

In one embodiment of the present disclosure, as shown in FIG. 1, the material supplying system further includes a feed valve 40, the material inlet 11 of the transfer cavity 10 is connected to the material storage device 30 through the feed valve 40, and the feed valve 40 is used for controlling the connection and disconnection between the material inlet 11 and the material storage device 30.

In the present solution, the feed valve 40 is configured to control the connection and disconnection of the material inlet 11, in this way, in the case of discontinuous feeding at the material outlet 12, when the power device is started, the connection and disconnection of the material inlet 11 may be controlled by the feed valve 40 to prevent the material in the transfer cavity 10 from generating backflow along the material inlet 11, and meanwhile, adverse effects such as wind energy loss at the material outlet 12 may be avoided to ensure the energy efficiency of the product. The feed valve 40 is arranged at the material inlet 11, the feed valve 40 may be a ball valve or other opening and closing mechanisms for controlling the connection and disconnection of the material inlet 11, in this way, in the case of discontinuous feeding at the material outlet 12, when a blower device 20 is started, the connection and disconnection of the material inlet 11 may be controlled by the feed valve 40 to prevent the material in the transfer cavity 10 from generating backflow along the material inlet 11, and meanwhile, adverse effects such as wind energy loss at the material outlet 12 may be avoided to ensure the energy efficiency of the product.

The material storage device 30 has an accommodating space, wherein the feed valve 40 of the material supplying system is connected to the material storage device 30, and when the feed valve 40 is opened, the material inlet 11 of the material supplying system communicates with the accommodating space of the material storage device 30.

Of course, the present solution is not limited thereto, and the feed valve 40 may not be provided. Specifically, in the case of the discontinuous feeding at the material outlet 12, the material inlet 11 may be blocked by the continuous flowing of the material at the material outlet 12 to achieve the purposes of reducing the wind energy loss and avoiding the backflow of the material.

In one embodiment, the power device is a blower device for blowing air into the transfer cavity. The blower device 20 is connected to the fluid inlet 13, and the blower device 20 may be a fan for blowing air into the transfer cavity. The blower device 20 is used for blowing air into the transfer cavity 10, in this way, the material in the transfer cavity 10 may be driven to be discharged from the material outlet 12 via wind power, and the material is further transported into a receiving device such as a cooking ware 50 of the cooking appliance to realize a transfer process of the material. Compared with the transport solution adopting a hydraulic impact manner, the wind power driving manner may realize dry material transport to avoid the problem of material residue caused by the attachment of the material on the inner wall of the pipeline by the water, thereby effectively ensuring the sanitary safety of the product. In addition, compared with the transport solution of using a gravity dropping manner in the prior at, the material is driven by wind power in the present solution to overcome the gravity of the material so as to transport and lift the material, so that the product may be applied to transportation occasions with different needs, which is conducive to product promotion in the field.

In one embodiment, since the fluid inlet 13 is arranged to be opposite to the material outlet 12, the material outlet 12 is located on a downstream position of the airflow direction, in addition, it is configured that the axis of the material inlet 11 passes through the area between the fluid inlet 13 and the material outlet 12. In this way, the material entering along the material inlet 11 may be directly accumulated in the area between the fluid inlet 13 and the material outlet 12, so that the airflow entering from the fluid inlet 13 may directly push out the material from the material outlet 12 along the downwind direction, thereby effectively improving the transport efficiency of the product, reducing the kinetic energy loss of the airflow in the transfer cavity 10 and effectively ensuring the energy efficiency of the product.

The blower device is a fan or an air pump.

In one embodiment, as shown in FIG. 1, the power device is a fan, the fan is used for blowing air into the transfer cavity 10 so as to drive the material to flow via the wind power. Compared with the solution of driving the material to flow via water power, the wall attachment and adhesion problem of the material caused by the water may be avoided, and the driving force loss of the air is less than that of the water, so that the energy consumption may be reduced.

Of course, the present solution is not limited thereto, and in the case of hydraulic driving, the power device may also be set as a water pump.

In some embodiments of the present disclosure, the material supplying system further includes an air inlet pipe 60, and the blower device 20 is connected to the fluid inlet 13 through the air inlet pipe 60, wherein the spatial layout of the blower device 20 may be facilitated by the air inlet pipe 60, and at the same time, the flexible connection between the blower device 20 and the fluid inlet may be realized, thereby achieving a vibration damping effect of the whole machine and reducing the running noise.

In one preferred embodiment of the present disclosure, the blower device 20 is a fan, and the fan is connected to the fluid inlet 13 through the air inlet pipe 60, wherein the pipe diameter of the air inlet pipe is uniform from one end of the air inlet pipe to the other end of the air inlet pipe, and such arrangement may relatively reduce the flow resistance at the air inlet pipe and improve the driving efficiency of the fluid.

In another preferred embodiment of the present disclosure, the blower device 20 is an air pump, the air pump is connected to the fluid inlet 13 through the air inlet pipe 60, wherein the pipe diameters of both ends of the air inlet pipe are greater than the pipe diameter at the middle, and the driving effect of the airflow by the air pump may be enhanced by the injection function of the air inlet pipe structure.

In one embodiment of the present disclosure, the material supplying system further includes a material transport pipe 70, one end of the material transport pipe 70 is connected to the material outlet 12, and the other end of the material transport pipe communicates with a cooking ware 50 of a cooking appliance. After the material flows out from the transfer cavity 10, it is transported by the material transport pipe 70 into the cooking ware 50, that is, the material outlet 12 is not directly connected to the cooking ware 50 of the cooking appliance, thereby being conducive to the spatial layout of the product and the cooking ware 50 of the cooking appliance, widening the application occasions of the product and facilitating the promotion of the product in the field.

The cooking appliance provided by the present embodiment includes a cooking main body and the material supplying system in any one of the above embodiments, and the cooking main body includes the cooking ware 50; and the material outlet 12 of the transfer cavity 10 of the material supplying system communicates with the cooking ware 50 so as to transport the material from the transfer cavity 10 into the cooking ware 50, wherein the cooking main body is used for cooking the material in the cooking ware 50.

The cooking appliance provided by the present disclosure is provided with the material supplying system In one embodiment, thereby having all the above beneficial effects, and is not described herein again.

In one specific embodiment of the present disclosure, as shown in FIG. 1, the transfer cavity 10 is provided with three interfaces, namely, the material inlet 11, the material outlet 12 and the fluid inlet 13; the material enters the transfer cavity 10 from the material inlet 11, after the feeding is completed, the feed valve 40 is closed (at this time, the wind power feeding effect is the best, and if the feed valve is not closed, the backflow of the material may be generated under the action of the wind power), then, the fan is started, and the material is discharged from the material outlet 12 to the transfer cavity 10 under the action of the wind power, and enters the cooking ware 50 through the material transport pipe 70.

In one specific embodiment of the present disclosure, as shown in FIG. 1, the material supplying system is located on the left side of the cooking ware 50, and the height of the position where the transfer cavity 10 of the material supplying system is located is less than the height of the position where the cooking ware 50 is located; and of course, the height of the position where the transfer cavity 10 of the material supplying system is located may also be designed to be greater than or equal to the height of the position where the cooking ware 50 is located in the present solution.

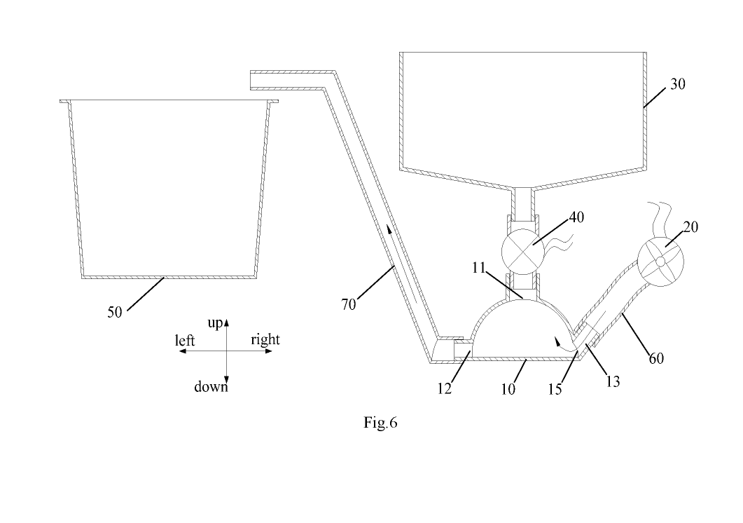

In one specific embodiment of the present disclosure, as shown in FIG. 6, the material supplying system is located on the right side of the cooking ware 50, and the height of the position where the transfer cavity 10 of the material supplying system is located is less than the height of the position where the cooking ware 50 is located. Of course, the height of the position where the transfer cavity 10 of the material supplying system is located may also be designed to be greater than or equal to the height of the position where the cooking ware 50 is located in the present solution.

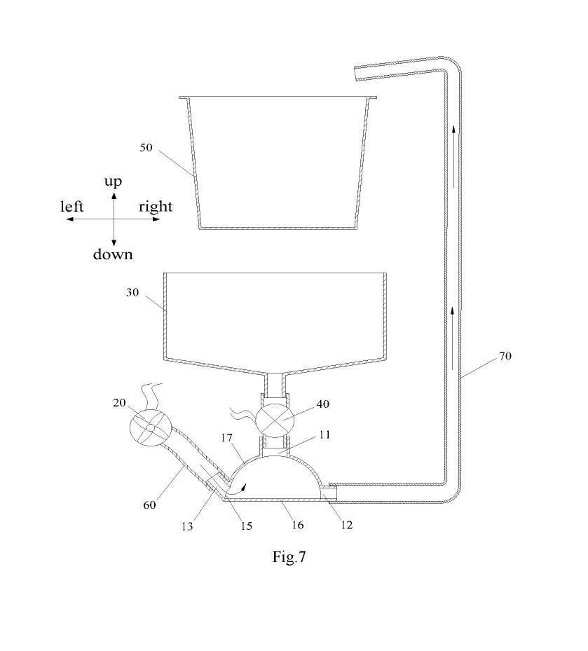

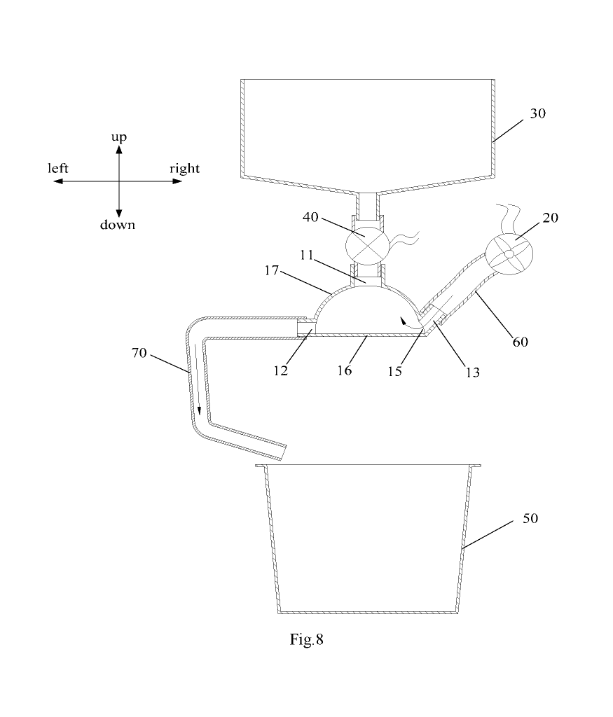

In one specific embodiment of the present disclosure, as shown in FIG. 7, the transfer cavity 10 of the material supplying system is located below the cooking ware 50.

In one specific embodiment of the present disclosure, as shown in FIG. 8, the transfer cavity 10 of the material supplying system is located above the cooking ware 50.

Of course, the present solution is not limited by the above specific embodiments. In fact, the material storage device 30 may be located at any position around the cooking ware 50.

In one embodiment, the cooking appliance is a rice cooker, an electric pressure cooker, an electric cooker, an electric steamer or a soybean milk machine.

In summary, in the transfer cavity provided by the present disclosure, the fluid inlet is arranged on the bottom wall of the transfer cavity or the position on the side wall of the transfer cavity that is relatively close to the bottom wall of the transfer cavity, so that the air may approximately enter the transfer cavity from the bottom of the transfer cavity, thereby being conducive to lifting and dispersing the material by wind power, and avoiding the problem that it is difficult to drive and discharge the material due to the accumulation of the material in the transfer cavity. Therefore, complete discharge and no residue in the transfer cavity may be ensured, and the hygienic security of the product may be improved.

Notwithstanding the appended claims, the present disclosure is also defined by the following clauses:

1. A material supplying system, applied to a cooking appliance, comprising:
a transfer cavity, wherein the transfer cavity is a hollow cavity and is provided with a material inlet for the inflow of a material, a fluid inlet for the entry of airflow, and a material outlet for the outflow of the material;
a blower device connected to the fluid inlet for blowing air into the transfer cavity; and
a material transport pipe, wherein one end of the material transport pipe is connected to the material outlet, and the other end of the material transport pipe communicates with a cooking ware of the cooking appliance.

2. The material supplying system according to clause 1, further comprising:
a feed valve, arranged at the material inlet for controlling the connection and disconnection of the material inlet.

3. The material supplying system according to clause 1 or 2, wherein
the fluid inlet is arranged on a bottom wall of the transfer cavity, or the fluid inlet is located at a position on a side wall of the transfer cavity that is relatively close to the bottom wall of the transfer cavity.

4. The material supplying system according to clause 3, wherein
in the case that the fluid inlet is located at the position on a side wall of the transfer cavity that is relatively close to the bottom wall of the transfer cavity, the minimum distance between an intersecting line of the fluid inlet on the transfer cavity and the bottom wall of the transfer cavity is 0-5 mm.

5. The material supplying system according to clause 1 or 2, wherein
the material outlet is arranged on the bottom wall of the transfer cavity, or the material outlet is located at the position on the side wall of the transfer cavity that is relatively close to the bottom wall of the transfer cavity.

6. The material supplying system according to clause 1 or 2, wherein
the fluid inlet is arranged to be opposite to the material outlet, and the axis of the material inlet passes through an area between the fluid inlet and the material outlet.

7. The material supplying system according to clause 1 or 2, wherein
the transfer cavity takes the shape of a three-way pipe; or,
the transfer cavity comprises a cavity bottom wall and a cavity top wall, the cavity top wall takes the shape of an upward protruding arc at the middle, and the edge of the cavity top wall is connected to the edge of the cavity bottom wall.

8. The material supplying system according to clause 1 or 2, wherein
the blower device is a fan or an air pump.

9. The material supplying system according to clause 1 or 2, further comprising:
an air inlet pipe, wherein the blower device is connected to the fluid inlet through the air inlet pipe.

10. The material supplying system according to clause 9, wherein
the pipe diameter of the air inlet pipe is uniform from one end of the air inlet pipe to the other end of the air inlet pipe; or the pipe diameters of both ends of the air inlet pipe are greater than the pipe diameter at the middle.

11. A kitchen storage appliance, comprising:
a material storage device having an accommodating space; and
the material supplying system according to any one of clauses 1-10, wherein the feed valve of the material supplying system is connected to the material storage device, and when the feed valve is opened, the material inlet of the material supplying system communicates with the accommodating space.

12. A cooking appliance, comprising:
a cooking main body comprising a cooking ware; and
the material supplying system according to any one of clauses 1-10, wherein the material outlet of the material supplying system communicates with the cooking ware.

13. The cooking appliance according to clause 12, further comprising:
a material storage device having an accommodating space, wherein the feed valve of the material supplying system is connected to the material storage device, and when the feed valve is opened, the material inlet of the material supplying system communicates with the accommodating space.

14. The cooking appliance according to clause 13, wherein
the height of the position of the material storage device is lower than or higher than that of the position of the cooking appliance; and/or,
the material storage device is located above or below the cooking appliance.

15. The cooking appliance according to any one of clauses 12-14, wherein
the cooking appliance is a rice cooker, an electric pressure cooker, an electric cooker, an electric steamer or a soybean milk machine.

In the present disclosure, the terms “connected”, “connection”, “fixed” and the like should be understood broadly. For example, “connection” may be a fixed connection, and may also be a detachable connection or an integral connection; and the “connected” may be directly connected and may also be connected through an intermediary.

In the description of the present specification, the description of the terms “one embodiment”, “some embodiments”, “specific embodiments” and the like means that the specific features, structures, materials or characteristics described in combination with the embodiments or examples are included in at least one embodiment or example of the present embodiment. In the present specification, the schematic representation of the above terms does not necessarily refer to the same embodiment or example. Furthermore, the specific features, structures, materials or characteristics described may be combined in a suitable manner in any one or more embodiments or examples.

1. A transfer cavity, comprising:
an inner cavity;
a material inlet for the inflow of a material;
a material outlet for the outflow of the material; and
a fluid inlet for entry of a fluid medium,
wherein the inner cavity communicates with the material inlet, the material outlet and the fluid inlet, and
wherein the fluid inlet is arranged on a bottom wall of the transfer cavity or positioned on a side wall of the transfer cavity that is relatively close to the bottom wall of the transfer cavity.

2. The transfer cavity according to claim 1, wherein,
a minimum distance T between an intersecting line of the fluid inlet on the transfer cavity and the bottom wall of the transfer cavity satisfies: T≤10 mm.

3. The transfer cavity according to claim 1, wherein
an included angle between an axis of the fluid inlet and the bottom wall of the transfer cavity is 0° to 90°, wherein the fluid medium entering from the fluid inlet is injected from the bottom wall of the transfer cavity or is injected onto the bottom wall of the transfer cavity and reflected by the bottom wall of the transfer cavity.

4. The transfer cavity according to claim 1, wherein
the fluid inlet is arranged to be opposite to the material outlet, and the axis of the material inlet passes through an area between the fluid inlet and the material outlet.

5. The transfer cavity according to claim 4, wherein
the material inlet faces to a center of the transfer cavity, the fluid inlet is located at a first end of the transfer cavity, and the material outlet is located on a second end of the transfer cavity relative to the fluid inlet.

6. The transfer cavity according to claim 1, wherein
the orientation of the fluid inlet deviates from a center of the transfer cavity, wherein the fluid medium entering from the fluid inlet flows around the center of the transfer cavity along a wall surface of the transfer cavity, and wherein the material inlet is located on the wall surface of the transfer cavity through which the fluid medium flows.

7. The transfer cavity according to claim 1, wherein
a minimum horizontal distance B between a lowest point of the intersecting line of the material inlet on the transfer cavity and an intersecting line of the fluid inlet on the transfer cavity satisfies: B≤10 mm.

8. The transfer cavity according to claim 1, wherein
the material outlet is located at a joint of the bottom wall of the transfer cavity and the side wall of the transfer cavity, and a height of the position where a lowest point of the material outlet is located is not greater than a height of the position where the inner surface of the bottom wall of the transfer cavity is located; or the material outlet is located on the bottom wall of the transfer cavity; or the material outlet is located at a position on the side wall of the transfer cavity that is relatively close to the bottom wall of the transfer cavity.

9. The transfer cavity according to claim 1, wherein,
the transfer cavity has a three-way pipe shape; or
a top wall of the transfer cavity has an upward protruding arc shape, and the side wall of the transfer cavity has an arc shape and is connected between the top wall of the transfer cavity and the bottom wall of the transfer cavity for transition.

10. The transfer cavity according to claim 1, wherein
the material inlet is located on the side wall of the transfer cavity or on the top wall of the transfer cavity.

11. A material supplying system, comprising:
a transfer cavity, comprising:
an inner cavity;
a material inlet for the inflow of a material;
a material outlet for the outflow of the material; and
a fluid inlet for entry of a fluid medium,
wherein the inner cavity communicates with the material inlet, the material outlet and the fluid inlet, and
wherein the fluid inlet is arranged on a bottom wall of the transfer cavity or positioned on a side wall of the transfer cavity that is relatively close to the bottom wall of the transfer cavity; and
a power device connected to the fluid inlet of the transfer cavity for driving the fluid medium to enter the transfer cavity.

12. The material supplying system according to claim 11, further comprising:
a material storage device connected to the material inlet of the transfer cavity, wherein the material storage device is configured to store the material, and the material stored in the material storage device is supplied to the transfer cavity.

13. The material supplying system according to claim 12, further comprising:
a feed valve, wherein the material inlet of the transfer cavity is connected to the material storage device through the feed valve, and the feed valve is configured to control the connection and disconnection between the material inlet and the material storage device.

14. The material supplying system according to claim 11, wherein
the power device is a blower device configured to blow air into the transfer cavity.

15. The material supplying system according to claim 14, wherein,
the blower device is a fan or an air pump.

16. The material supplying system according to claim 14, further comprising:
an air inlet pipe, wherein the blower device is connected to the fluid inlet through the air inlet pipe.

17. The material supplying system according to claim 16, wherein,
a pipe diameter of the air inlet pipe is uniform from a first end of the air inlet pipe to a second end of the air inlet pipe; or pipe diameters of both the first and second ends of the air inlet pipe are greater than the pipe diameter at a middle.

18. The material supplying system according to claim 11, further comprising:
a material transport pipe, wherein the first end of the material transport pipe is connected to the material outlet of the transfer cavity, and a second end of the material transport pipe communicates with a cooking ware of a cooking appliance.

19. A cooking appliance, comprising:
a cooking main body comprising a cooking ware; and
a material supplying system, comprising:
a transfer cavity, comprising:
an inner cavity;
a material inlet for the inflow of a material;
a material outlet for the outflow of the material; and
a fluid inlet for entry of a fluid medium,
wherein the inner cavity communicates with the material inlet, the material outlet and the fluid inlet, and
wherein the fluid inlet is arranged on a bottom wall of the transfer cavity or positioned on a side wall of the transfer cavity that is relatively close to the bottom wall of the transfer cavity; and
a power device connected to the fluid inlet of the transfer cavity for driving the fluid medium to enter the transfer cavity,
and wherein the material outlet of the transfer cavity of the material supplying system communicates with the cooking ware.

20. The cooking appliance according to claim 19, wherein,
a height of a position of the material storage device of the material supplying system is lower than or higher than a position of the cooking appliance; and/or,
the material storage device of the material supplying system is located above or below the cooking appliance, and
wherein the cooking appliance is a rice cooker, an electric pressure cooker, an electric cooker, an electric steamer or a soybean milk machine.

21. (canceled)
